(19) United States
(12) Patent Application Publication
(10) Pub. No.: US 2022/0205280 A1
(43) Pub. Date: Jun. 30, 2022

(54) DOOR LOCK STRUCTURE FOR PET CAGE

(71) Applicant: JIANGSU ZHONGHENG PET ARTICLES JOINT-STOCK CO., LTD., Yancheng (CN)

(72) Inventor: Bin QIU, Yancheng (CN)

(73) Assignee: JIANGSU ZHONGHENG PET ARTICLES JOINT-STOCK CO., LTD., Yancheng (CN)

(21) Appl. No.: 17/368,799

(22) Filed: Jul. 6, 2021

(30) Foreign Application Priority Data
Dec. 24, 2020 (CN) 202011551426.8

(51) Int. Cl. E05B 63/14; A01K 1/02

(52) U.S. Cl. CPC E05B 63/146; A01K 1/0245

(57) ABSTRACT

The present invention discloses a door lock structure for a pet cage. The door lock structure comprises a cage body on which at least one entrance and exit and a cage door matched with the entrance and exit are arranged. A plurality of pivot rings is arranged on one side of the cage door, sleeves a door frame on the edge of the entrance and is rotatable about the door frame. At least two limit sliding rods which are parallel to each other are arranged on the cage door, and a lock that is slidable on the limit sliding rods is installed on the limit sliding rods. The lock comprises a traveling mechanism that clamps the limit sliding rods, and a plurality of tension springs is installed on one side of the traveling mechanism close to the door frame. A plurality of lock bolt assemblies that moves synchronously with the traveling mechanism is also arranged on the traveling mechanism, and the lock bolt assemblies are matched with and locked with lock hole mechanisms provided on the corresponding door frame. The door lock structure is simple and exquisite in structure and design. Through the joint action of the traveling mechanism, the lock bolts and the tension springs, on the one hand, a plurality of lock bolts can be controlled at the same time; on the other hand, a plurality of parts of the cage door can be locked. The door block structure is simple and reliable and is easy to operate.

### TECHNICAL FIELD

The present invention relates to a cage door structure, in particular to a door lock structure for a pet cage and a use method thereof, belonging to the technical field of pet supplies.

### BACKGROUND

With the continuous development of economic globalization, people's living standards have been greatly improved, and their spending power has also been greatly improved. Therefore, under the influence of new lifestyles and development waves, more and more people choose pets as their important companions. Keeping pets has many benefits. For example, it can make people feel less lonely, have more sense of security, relieve people's huge work pressure, and cultivate their temperament, and so on.

All kinds of pets continue to enter the lives of ordinary people, and they naturally have irreplaceable value for other things. Among all pets, pet cats and dogs are the most common. A dog cage is a must-have place for a pet dog to entertain and roost. At present, a dog cage is composed of a number of fasteners and six separate frames for forming a pet cage. The six separate frames include an upper frame, a lower frame, a front frame, a rear frame, a left frame, and a right frame, each frame having a grille inside, and the front frame having a cage door inside. One side of the cage door is movably connected to a main body of the pet cage through a pivot ring. The pivot ring sleeves a mesh wire on the edge of the entrance end, so that the cage door rotates between an open position and a closed position. The other side of the cage door is locked with the main body of the pet cage through a locking mechanism. However, the locking mechanism is generally arranged in the middle, so the upper and lower corners of the cage door are easily deformed under the action of an external force, forming a gap. This is especially true for large dogs. Therefore, involving a more stable cage door is an urgent technical problem to be solved in the manufacture of such dog cage.

The Chinese patent CN208609627U discloses a dog cage with a double locking mechanism. The dog cage comprises a cage body, wherein at least one entrance is provided on the side of the cage body, and a cage door is provided at the entrance. Each of the cage body and the cage door is of a grid mesh structure. A pivot ring is arranged on one side of the cage door and sleeves a mesh wire on the edge of the entrance end, such that the cage door rotates between an open position and a closed position. The other side of the cage door is locked with the cage body through a locking mechanism. The dog cage has a good locking effect between the cage door and the cage body. This double-lock structure can indeed solve this technical problem, but creates a new problem, that is, it is too troublesome to open and close the door each time, which needs to be completed twice.

### SUMMARY

An objective of the present invention is to provide a door lock structure for a pet cage and a use method thereof. The door lock structure is convenient for a cage door to open and close, and firm and reliable, so as to solve the above-mentioned technical problems in the prior art.

The objective of the present invention is achieved by the following technical solution.

A door lock structure for a pet cage comprises a cage body on which at least one entrance and exit and a cage door matched with the entrance and exit are arranged, wherein a plurality of pivot rings is arranged on one side of the cage door, sleeves a door frame on the edge of the entrance and is rotatable about the door frame; at least two limit sliding rods which are parallel to each other are arranged on the cage door, and a lock that is slidable on the limit sliding rods is installed on the limit sliding rods; the lock comprises a traveling mechanism that clamps the limit sliding rods, and a plurality of tension springs is installed on one side of the traveling mechanism close to the door frame, wherein the other end of each tension spring is fixed to the edge of the cage door, a plurality of lock bolt assemblies that moves synchronously with the traveling mechanism is also arranged on the traveling mechanism, and the lock bolt assemblies are matched with and locked with lock hole mechanisms provided on the corresponding door frame.

Each of the cage body and the cage door is of a grid mesh structure.

Each lock bolt assembly comprises at least two lock bolts, which are located in the middle and on the upper and lower ends of the cage door, respectively. In this way, the cage door and the door frame can be fixed more firmly, thereby avoiding the problem of gaps formed by the deformation of upper and lower ends. Each lock bolt assembly is connected to the traveling mechanism through a vertical arm perpendicular to the corresponding limit sliding rod. Preferably, each lock bolt assembly is a closed area wound by an iron wire, the area being of a “C” or “E” structure. When the area is of the “C” structure, the middle lock bolt is arranged on the traveling mechanism.

In consideration of relatively large spans of the lock bolt assemblies, a plurality of locking bolt limiting slideways is arranged on the outer side of the vertical arm between the traveling mechanism and each locking bolt, and the vertical arm slides in the locking bolt limiting slideways. By means of such arrangement, the lock bolt assemblies can be kept from deforming even under the action of an external force, so that the lock bolt assemblies always move along a virtual plane where the cage door is located.

Each lock hole mechanism is fixed to a lock ring on the door frame or the door frame itself, and the uppermost and lowermost sides of the cage door are arranged on the outside of the door frame, such that the cage door will be restricted by the door frame and cannot rotate into the cage.

When each lock hole mechanism is a lock ring, the lock ring is welded to a vertical fence of the cage body.

The traveling mechanism comprises two traveling units, which are combined together by screws and sleeved with the limit sliding rods through limiting holes reserved on the inner sides of the two traveling units. In order for easy installation, a virtual cylinder of each limiting hole is divided into two equal limiting hole units by a symmetry plane passing through its center axis, and the two limiting hole units are respectively formed on the sides, which are close to each other, of the two traveling units.

The cage body is composed of six surfaces, and every two adjacent surfaces are fixed by fixing hooks.

A handle is arranged on the top of the cage body, for being convenient to carry and move.

The present invention has the following beneficial effects: the door lock structure is simple and exquisite in structure and design. Through the joint action of the traveling mechanism, the lock bolts and the tension springs, on the one hand, a plurality of lock bolts can be controlled at the same time; on the other hand, a plurality of parts of the cage door can be locked. The door block structure is simple and reliable and is easy to operate.

### BRIEF DESCRIPTION OF THE DRAWINGS

FIG. 1 is a schematic structural diagram of a cage door in a closed state in the present invention;

FIG. 2 is a schematic structural diagram of the cage door in an open state in the present invention;

FIG. 3 is an enlarged view of Part A in FIG. 2;

FIG. 4 is an enlarged schematic structural diagram of a portion A of the door lock of the present invention in a closed state.

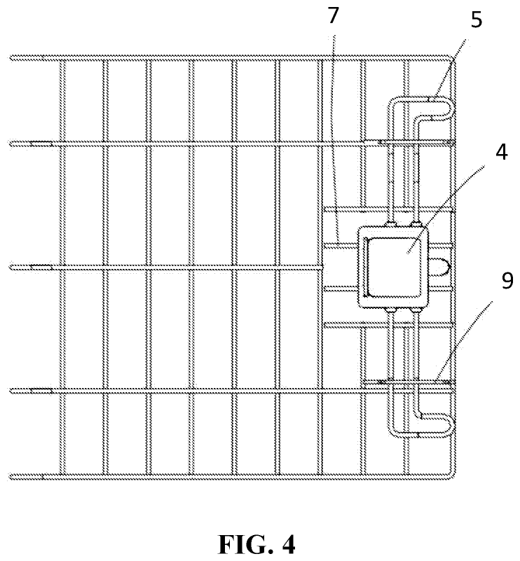

In drawings, reference symbols represent the following components: 1—cage body; 2—cage door; 3—pivot ring, 4—traveling mechanism; 5—lock bolt assembly; 6—tension spring; 7—limit sliding rod; 8—handle; 9—lock bolt limiting slideway.

### DETAILED DESCRIPTION

The technical features of the present invention are further described below in conjunction with the accompanying drawings and specific embodiments.

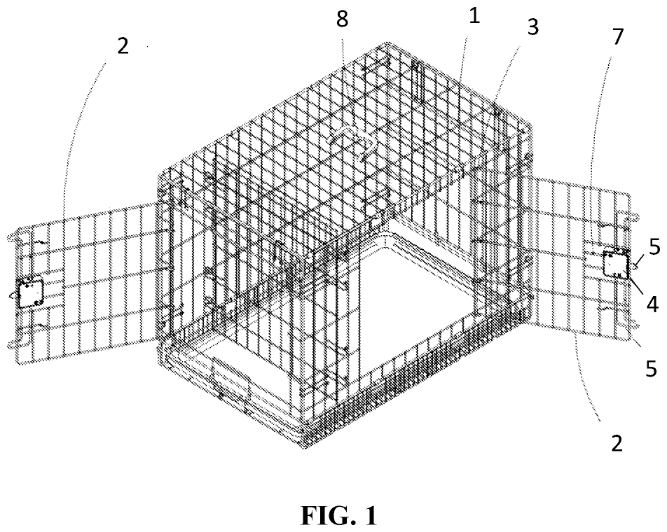

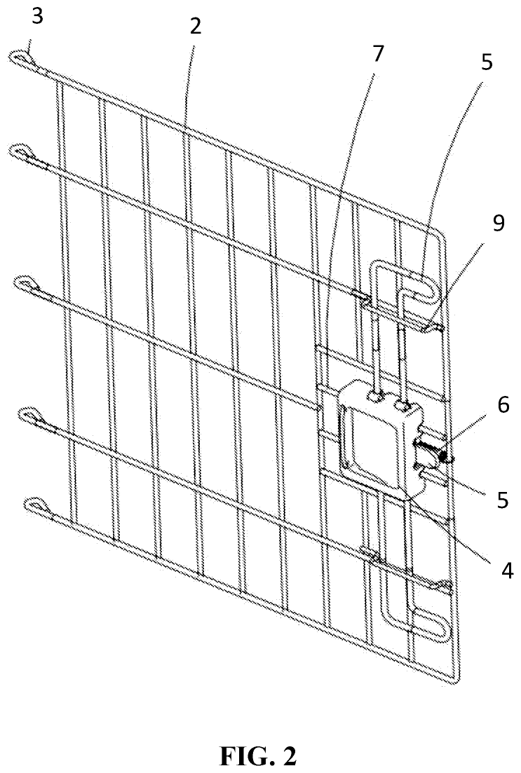

The present invention provides a door lock structure for a pet cage as shown in FIG. 1 and FIG. 2, and a use method thereof. The pet cage comprises a cage body 1, wherein at least one entrance is arranged on the side of the cage body 1, and a cage door 2 is arranged at the entrance; a plurality of pivot rings 3 is arranged on one side of the cage door 2, sleeves a door frame on the edge of the entrance and is rotatable about the door frame; at least two limit sliding rods 7 which are parallel to each other are arranged on the cage door 2, and a lock that is slidable on the limit sliding rods 7 is installed on the limit sliding rods 7; the lock comprises a traveling mechanism 4 that clamps the limit sliding rods 7, and a plurality of tension springs 6 is installed on one side of the traveling mechanism 4 close to the door frame, wherein the other end of each tension spring 6 is fixed to the edge of the cage door 2; a plurality of lock bolt assemblies 5 that moves synchronously with the traveling mechanism 4 is also arranged on the traveling mechanism 4, and the lock bolt assemblies 5 are matched with and locked with lock hole mechanisms provided on the corresponding door frame.

Each of the cage body 1 and the cage door 2 is of a grid mesh structure.

Each lock bolt assembly 5 comprises at least two lock bolts, which are located in the middle and on the upper and lower ends of the cage door 2, respectively. In this way, the cage door 2 and the door frame can be fixed more firmly, thereby avoiding the problem of gaps formed by the deformation of upper and lower ends. Each lock bolt assembly 5 are connected to the traveling mechanism 4 through a vertical arm perpendicular to the corresponding limit sliding rod 7. Preferably, each lock bolt assembly 5 is a closed area wound by an iron wire, the area being of a “C” or “E” structure. When the area is of the “C” structure, the middle lock bolt is arranged on the traveling mechanism.

In consideration of relatively large spans of the lock bolt assemblies 5, a plurality of locking bolt limiting slideways 9 is arranged on the outer side of the vertical arm between the traveling mechanism 4 and each locking bolt, and the vertical arm slides in the locking bolt limiting slideways 9. By means of such arrangement, the lock bolt assemblies 5 can be kept from deforming even under the action of an external force, so that the lock bolt assemblies always move along a virtual plane where the cage door 2 is located.

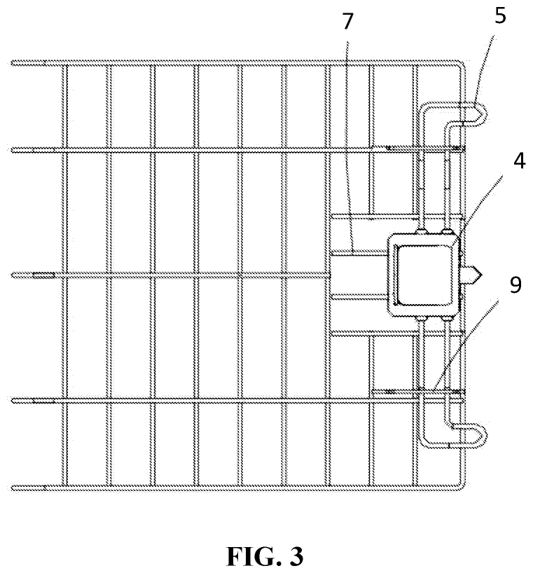

As shown in FIG. 3, each lock hole mechanism is fixed to a lock ring on the door frame or the door frame itself; and the uppermost and lowermost sides of the cage door 2 are arranged on the outside of the door frame, such that the cage door 2 will be restricted by the door frame and cannot rotate into the cage.

When each lock hole mechanism is a lock ring, the lock ring is welded to a vertical fence of the cage body.

The traveling mechanism 4 comprises two traveling units, which are combined together by screws and sleeved with the limit sliding rods 7 through limiting holes reserved on the inner sides of the two traveling units. In order for easy installation, a virtual cylinder of each limiting hole 7 is divided into two equal limiting hole units by a symmetry plane passing through its center axis, and the two limiting hole units are respectively formed on the sides, which are close to each other, of the two traveling units.

The cage body 1 is composed of six surfaces, and every two adjacent surfaces are fixed by fixing hooks.

A handle 8 is arranged on the top of the cage body 1, for being convenient to carry and move.

The use method of the cage door for the pet cage comprises the following steps:

(1) when the cage door needs to be closed, the traveling mechanism is pulled with a hand to move toward one side of the pivot ring to drive the lock bolt to move until the end of the lock bolt do not exceed the corresponding lock hole mechanism; the hand is loosened after the cage door is closed; the tension springs drive the traveling mechanism to reset; the traveling mechanism drives the lock bolt to move toward one side of the corresponding lock hole mechanism, and to lock the cage door together with the lock hole mechanism, and

(2) when the cage door needs to be opened, the traveling mechanism is pulled with a hand to move toward one side of the pivot ring to drive the lock bolt to move until the end of the lock bolt do not exceed the corresponding lock hole mechanism; and the hand is loosened after the cage door is opened.

The above embodiments are merely preferred embodiments of the present invention but are not intended to limit the present invention. Although the present invention is described in detail with reference to the above embodiments, a person skilled in the art should understand: the technical solutions described in the foregoing embodiments may also be modified, or some of the technical features may be equivalently replaced. Thus, any modification, equivalent replacement, improvement and so on made within the spirit and principle of the present invention shall be encompassed by the protection scope of the present invention.

What is claimed is:

1. A door lock structure for a pet cage, comprising a cage body on which on which at least one entrance and exit and a cage door matched with the entrance and exit are arranged, wherein a plurality of pivot rings is arranged on one side of the cage door, sleeves a door frame on the edge of the entrance and is rotatable about the door frame; at least two limit sliding rods which are parallel to each other are arranged on the cage door, and a lock that is slidable on the limit sliding rods is installed on the limit sliding rods, the lock comprises a traveling mechanism that clamps the limit sliding rods, and a plurality of tension springs is installed on one side of the traveling mechanism close to the door frame, wherein the other end of each tension spring is fixed to the edge of the cage door; a plurality of lock bolt assemblies that moves synchronously with the traveling mechanism is also arranged on the traveling mechanism, and the lock bolt assemblies are matched with and locked with lock hole mechanisms provided on the corresponding door frame.

2. The door lock structure for the pet cage according to claim 1, wherein each of the cage body and the cage door is of a grid mesh structure.

3. The door lock structure for the pet cage according to claim 1, wherein each lock bolt assembly comprises at least two lock bolts, which are located on the upper end and the lower end of the cage door, respectively.

4. The door lock structure for the pet cage according to claim 3, wherein each lock bolt assembly is connected to the traveling mechanism through a vertical arm perpendicular to the corresponding limit sliding rod.

5. The door lock structure for the pet cage according to claim 4, wherein a plurality of locking bolt limiting slideways is arranged on the outer side of the vertical arm between the traveling mechanism and each locking bolt, and the vertical arm slides in the locking bolt limiting slideways.

6. The door lock structure for the pet cage according to claim 3, wherein each lock bolt assembly is a closed area wound by an iron wire, the area being of a “C” or “E” structure; and when the area is of the “C” structure, the middle lock bolt is arranged on the traveling mechanism.

7. The door lock structure for the pet cage according to claim 1, wherein each lock hole mechanism is fixed to a lock ring on the door frame or the door frame itself; and the uppermost and lowermost sides of the cage door are arranged on the outside of the door frame.

8. The door lock structure for the pet cage according to claim 1, wherein, when each lock hole mechanism is a lock ring, the lock ring is welded to a vertical fence of the cage body.

9. The door lock structure for the pet cage according to claim 1, wherein the traveling mechanism comprises two traveling units, which are combined together by screws and sleeved with the limit sliding rods through limiting holes reserved on the inner sides of the two traveling units.

10. The door lock structure for the pet cage according to claim 9, wherein a virtual cylinder of each limiting hole is divided into two equal limiting hole units by a symmetry plane passing through its center axis, and the two limiting hole units are respectively formed on the sides, which are close to each other, of the two traveling units.

11. The door lock structure for the pet cage according to claim 1, wherein the cage body is composed of six surfaces, and every two adjacent surfaces are fixed by fixing hooks.

12. The door lock structure for the pet cage according to claim 1, wherein a handle is arranged on the top of the cage body.
